(19) United States
(12) Patent Application Publication
(10) Pub. No.: US 2017/0344624 A1
(43) Pub. Date: Nov. 30, 2017

(54) MODIFYING A PRESENTATION OF SOCIALLY SHARED ITEMS BASED ON LOCATING A USER IN REAL-TIME

(71) Applicant: International Business Machines Corporation, Armonk, NY (US)

(72) Inventors: Lisa Seacat DeLuca, Baltimore, MD (US); Jeremy A. Greenberger, Raleigh, NC (US)

(21) Appl. No.: 15/162,646

(22) Filed: May 24, 2016

(51) Int. Cl. G06F 17/30; G06Q 30/02; G06Q 50/00; H04W 4/02

(52) U.S. Cl. CPC G06F 17/30601; H04W 4/021; G06F 17/30528; G06Q 30/0261; G06Q 50/01

(57) ABSTRACT

An embodiment for adjusting a displayed organization of a representative collection of items. The method includes a computer processor identify a first user within a first location that includes determining a first set of location information associated with the first user within the first location and information associated with the first location. The method further includes identifying a first group of representations of items of interest of the first user and a first organization of the first group of representations. The method further includes generating a second organization of the first group of representations of items by modifying the first organization of the first group of representations of items where the generated second organization is based on the first set of location information associated with the user within the first location and rendering the second organization of the first group of representations of items for display by an electronic device.

### BACKGROUND OF THE INVENTION

The present invention relates generally to the field of social media, and more particularly to modifying the presentation of social networking items based on location information of a user.

Developments in cellular and computing technology have resulted in the proliferation of smart mobile electronic devices, such as smartphones, tablet computers, and wearable devices with advanced capabilities, such as digital eyeglasses (e.g., smart glasses) and smart watches. Mobile devices contribute to the growing network of social interactions and the connectedness of users via social sharing websites where users share information, opinions, images, videos, etc. Various indications of interest for items identified within a social sharing website include: flagging, applying a focus, ranking, etc. Some social sharing websites include concepts, such as “like” and “pinning” to signify an item of interest. In one example, groups and/or collections of items of interest are included (e.g., linked) on pinboards, more commonly identified as “boards.”

Advances in locating technologies enable positioning systems to locate mobile devices, objects and/or people using radio waves, magnetic fields, acoustic signals, or other sensory information collected by mobile devices. Location data associated with a user can add context to items associated with the user that are stored on a social sharing website.

### SUMMARY

According to embodiments of the present invention, there is a method, computer program product, and/or system for adjusting a displayed organization of a representative collection of items. The method includes a computer processor identify a first user within a first location. The method further includes determining a first set of location information associated with the first user within the first location and information associated with the first location. The method further includes identifying a first group of representations of items of interest of the first user and a first organization of the first group of representations of items. The method further includes generating a second organization of the first group of representations of items by modifying the first organization of the first group of representations of items where the generated second organization is based on the first set of location information associated with the user within the first location. The method further includes rendering the second organization of the first group of representations of items for display by an electronic device.

### BRIEF DESCRIPTION OF THE DRAWINGS

FIG. 1 illustrates a networked computing environment, in accordance with an embodiment of the present invention.

FIG. 2 depicts a flowchart of the operational steps of a social interest program, in accordance with an embodiment of the present invention.

FIG. 3 depicts a flowchart of the operational steps of a user monitoring program, in accordance with an embodiment of the present invention.

FIG. 4 is a block diagram of components of a computer, in accordance with an embodiment of the present invention.

### DETAILED DESCRIPTION

Embodiments of the present invention recognize that social networking and social sharing include but are not limited to: conversations, opinions, and images of people, places, and things of interest that a user posts to a social networking/sharing website; herein identified as a social sharing site. Various social sharing sites are of increased interest to consumers and users interested in “do it yourself” projects (e.g., DIYers). Some such social sharing sites allow images of products to be bookmarked, tagged, copied, and/or uploaded to the website. Embodiments of the present invention also recognize that a user can utilize a social sharing site to personalize and/or create customized groups of images (e.g., representative of items of interest) for: the user, one or more groups of other users defined by the user, and/or publically available (e.g., to members of the social sharing site). Merchants with physical stores (e.g., locations) may have websites and software applications (apps) that customers can utilize via mobile devices while traversing a location of the merchant. However, an app of a merchant and/or the physical location of the merchant is disconnected from the socially shared information or items of interest that a consumer identifies within a social sharing site.

Embodiments of the present invention monitor a user, in real-time, moving within various physical environments, herein identified as venues. Embodiments of the present invention identify one or more organizations (e.g., groups) of representations of various items of interest of a user that the user includes within a social sharing site. Embodiments of the present invention present a modified organization (e.g., group) of the representative items via a mobile device of a user based, at least in part, on a location of the user within a venue. In some embodiments of the present invention the number and organization of representative items within a group mimics the groupings of a social sharing website. Other embodiments of the present invention may use various user preferences to define the organizational and display parameters associated with groups of social items. Embodiments of the present invention can be utilized for various types of items that are of interest to a user, such as uniform resource locators (URLs), messages, images, videos, audio files, etc.

Embodiments of the present invention can be utilized by a user and/or a plurality of entities, such as organizations, retailers, businesses, and/or proprietors operating within various physical environments to provide feedback, via a mobile device of the user by manipulating the presentation of representations of the items of interest. Items of interest included in a social sharing site utilized by a user are herein identified as social items. At least one embodiment of the present invention enables two or more users to interact collaboratively within the same venue and/or different venues by posting social items on a common social sharing site.

Some embodiments of the present invention utilize an indoor positioning system (IPS) that more accurately determines the position of a mobile device of a user within a venue. Other embodiments of the present invention determine a location of a user based on zones (e.g., geo-fenced locations) within the venue. Each zone may be further described with respect to items stored or displayed within the zone of the venue.

Other embodiments of the present invention may utilize communication functions integrated with an IPS to: identify a mobile device of a user (e.g., customer), track the mobile device of the user, identify a social sharing site utilized by the user while user visits the venue, communicate alerts to a user, and identify interactions with a customer service representative. Various embodiments of the present invention utilize analytics to refine locating a user and analyzing activities of the user within a venue. For example, analytics can further define location information of a user with respect to: position, movement paths, dwell times in a position and speed of movement within a venue.

Embodiments of the present invention utilize one or more computers external to a mobile computing device (e.g., a smartphone) of a user to identify and analyze data (e.g., social items) already input by a user to a social sharing site and providing various organizations of the data based on a real-time position of the user. In addition, some embodiments of the present invention utilize a network of a venue visited by a user to communicate one or more organizations of items of interest; thereby reducing telecommunication bandwidth, telecommunication costs, and battery usage associated with the user viewing, sorting, and searching items of interest of the user included in a social sharing site. Other embodiments of the present invention may utilize various analytics and/or cognitive functions that further analyze a social share and/or metadata corresponding to the social share to identify additional information reducing and possibly eliminating further searches of the Internet by the user. For example, in response to identifying a user visit to a clothing store, an embodiment of the present invention may identify related wardrobe items associated with a social share and present an organization of images of the related items and/or alert the user in response to the user being in proximity to a related item.

Some embodiments of the present invention enable one or more computing systems of a merchant associated with a venue, access to behavioral information of users that visit a venue and items of interest of the users that visit the venue; thereby enabling the merchant to improve the shopping experience associated with the venue while reducing the need for user (e.g., customer) surveys, which are associated a lag-time and consumption of computing resources. By utilizing computer-based beacons and transceivers within a venue, embodiments of the present invention can more accurately identify and locate a user within the venue, thereby reducing some requirements of the network within the venue. In addition, embodiments of the present invention that utilize computer-based beacons and transceivers associated with an IPS within a venue are more accurate than video-based tracking and do not require additional computing resources that are needed to process images associated with video-based tracking of users.

Further, one skilled in the art would recognize that communication of information to a user is a function of many computing systems. By reducing or eliminating the number of searches needed to find data and the lag time required to organize results via user input, the overall ability of a computing system to identify and present results in a meaningful way is increased. As such, the functioning of such a computing system is seen to be improved in at least this aspect.

The descriptions of the various scenarios, instances, and examples related to the present invention have been presented for purposes of illustration but are not intended to be exhaustive or limited to the embodiments disclosed. Embodiments of the present invention may also be utilized in other venues and/or environments that include transceivers, beacons, wireless nodes (e.g., access points) and/or other wireless monitoring technologies to determine activities (e.g., location, motion, etc.) associated with a user. For example, embodiments of the present invention may be utilized within: a trade show, a convention, a special event (e.g., a pet show, a bridal show, a festival), a fair, a carnival, a business district, etc. In this example, each vendor area/booth may utilize one or more monitoring technologies that identify a user and track activities (e.g., location, motion, etc.) of the user in and around a vendor area/booth. Although the present invention describes a solution for an indoor positioning system, a person skilled in the art will recognize that this invention will apply to any designated environment (e.g., outdoor marketplace, subway stations, parking lots, sports venues) that uses a positioning system with a network that may or may not rely on global positioning system (GPS) satellites.

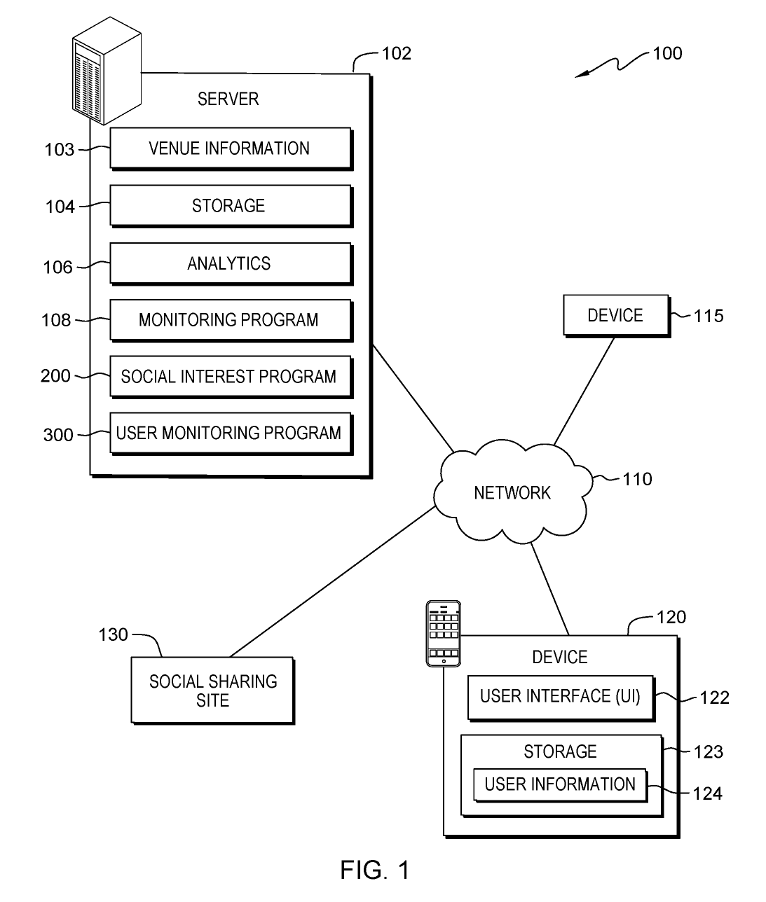

The present invention will now be described in detail with reference to the Figures. FIG. 1 is a functional block diagram illustrating networked computing environment 100, in accordance with embodiments of the present invention. An embodiment, networked computing environment 100 includes: server 102, device 115, device 120, and social sharing site 130, all interconnected over network 110. In some embodiments, networked computing environment 100 may include multiple instances of device 115. Many modifications to the depicted environment may be made by those skilled in the art without departing from the scope of the invention as recited by the claims.

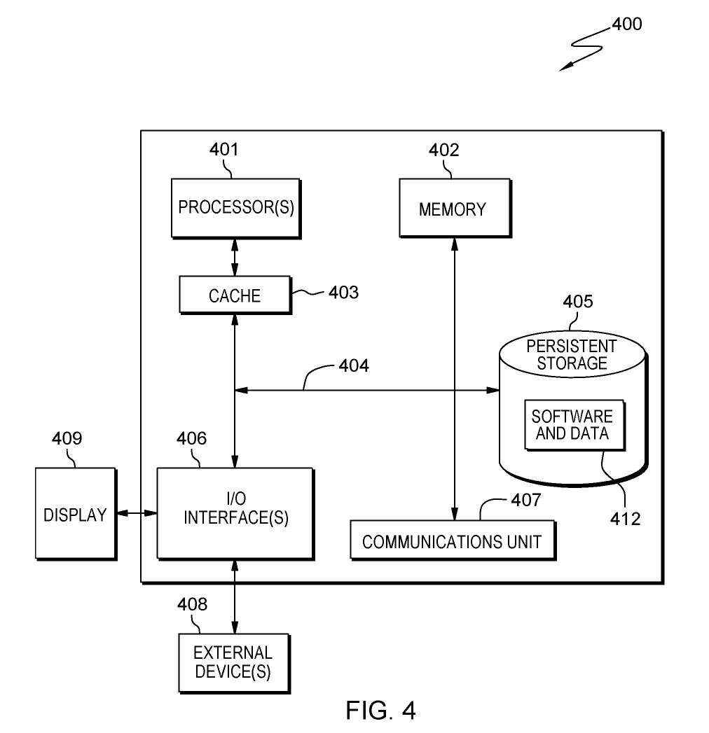

Server 102, device 115, device 120, and social sharing site 130 may be: laptop computers, tablet computers, netbook computers, personal computers (PC), desktop computers, personal digital assistants (PDA), smartphones, wearable devices (e.g., digital eyeglasses, smart glasses, smart watches, personal fitness devices, personal safety devices), or any programmable computer systems known in the art. In certain embodiments, server 102 and social sharing site 130 represent computer systems utilizing clustered computers and components (e.g., database server computers, application server computers, etc.) that act as a single pool of seamless resources when accessed through network 110, as is common in data centers and with cloud-computing applications. In general, server 102, device 115, and social sharing site 130 are representative of any programmable electronic device or combination of programmable electronic devices capable of executing machine readable program instructions and communicating with a user device 120 via network 110. Server 102, device 115, device 120, and social sharing site 130 may include components, as depicted and described in further detail with respect to FIG. 4, in accordance with embodiments of the present invention.

Server 102 includes: venue information 103, storage 104, analytics 106, monitoring program 108, social interest program 200, user monitoring program 300, and various programs and databases (e.g., a website interface, geo-locating software, a database management system, an e-mail server, image recognition software, etc.) (not shown).

Venue information 103 includes: files, tables, databases that include identifiers for one or more instances of device 115, wireless access points of network 110 within a venue, and other devices, such as beacons and transceivers of a locating system (not shown) utilized by server 102. The locating system may be an IPS and/or wireless-based positioning system (WPS). In one embodiment, venue information 103 also includes a map and/or floor plan of a venue (e.g., a retail environment) and a cross-reference linked to information in storage 104 that identifies one or more locations of displays, inventory and/or items (e.g., merchandise) within a venue. In some embodiments, venue information 103 includes: tags, keywords and/or metadata associated with items of the venue that are utilized to identify a location of a user that corresponds to an item of interest based on shares, comments, posts, boards, etc. of a user within a social sharing site.

In a further embodiment, venue information 103 may also include: merchandise information and/or inventory data such as, a quantity for items (e.g., merchandise) that are stocked by a venue, a price for the items that are stocked, a status (e.g., on order, clearance, backordered, discontinued, promotional, etc.) for stocked items, cross-marketing information among stocked items, supplier discounts for stocked items, rebates for stocked items, etc. In another embodiment, venue information 103 includes a cross-reference of information that identifies one or more items of the venue that include RFID tags.

In various embodiments, venue information 103 may be dynamically modified based on identifying a bulk movement of items that include RFID tags that may be detected by a transceiver (e.g., device 115) and/or information input (e.g., via a hand scanner) by a customer service representative of the venue. In an example, a pallet of items may be placed in an ad-hoc sales display that is at a location in the venue that is different from the location of similar items; this may add a temporary zone to venue information 103. In another example, depletion of inventory may shrink one or more zones within venue information 103 associated with one or more instances of device 115.

Storage 104 stores and/or caches data and information utilized by various programs of server 102. In one embodiment, storage 104 caches location and movement data of an ISP (not shown) that is processed by monitoring program 108. In some embodiments, storage 104 includes data for a plurality of users within a venue. The data of the plurality of users includes, but is not limited to: mobility data (e.g., speed, locations, directions, dwell times, etc.) for the plurality of users, identity information for instances of device 120, identity information of the users, vendor app data, and information associated with one or more users, such as demographics.

In another embodiment, storage 104 also includes, but is not limited to, user preferences and/or temporary information, such as minimum dwell times (e.g., dwell time threshold values), opt-ins and opt-outs for various social sharing sites, interest board organization preferences, one or more temporary venue boards, shopping cart items, a frequency of receiving alerts, a method of receiving alerts, predefined messages, etc. Storage 104 may also include additional information, triggers, and threshold values that describe and/or define parameters utilized to analyze the movement/activities of a user. In one example, storage 104 may include a parameter that defines a dwell time with respect to a time that a user is stationary. In another example, storage 104 may include speed and path parameters that define dwell time with respect to a reduced speed of a user and a constrained area traversed by the user, such as a period of time associated with the user browsing back and forth between one or two adjacent storage racks of a venue. Storage 104 may also include user preferences related to parameters of an organizational depiction, such as an order of items, a number of items of an organization, highlighting associated with a social item, a size of an image representing a social item, a text bubble included with an image of a social item, and an organization of social items (e.g., a slide show, an array, etc.).

Analytics 106 includes a suite of software capable of: predictive modeling analytics, image recognition, speech recognition, machine learning, statistical analysis, database searches, fuzzy logic, natural language processing, a dictionary function, etc. In an example, analytics 106 includes a thesaurus to identify synonyms of metadata tags associated with items of interest (e.g., social items) to improve a contextual analysis of a representation of an item of interest. In some embodiments, analytics 106 may also include various business analytics, such as behavioral analytics, cohort analysis, marketing analytics, etc. Analytics 106 may utilize behavior analytics that further characterize a user within a venue based on location, direction, and dwell time. Examples of characterizations of a user include: a roaming customer (e.g., long distance, short dwell times, random paths), a focused customer (e.g., short dwell times, direct paths, quickly traversed), and a project planner (e.g., long dwell time, paths traversed related merchandise/accessories, and utilizes customer server representative). Analytics 106 may also identify others patterns of a user, such as identifying a possible item of interest in a zone of a venue based on a cumulative dwell time, where a user returns to a zone one or more times and slows down but does not stop, as if contemplating a decision.

In various embodiments, analytics 106 includes big-data capabilities to: analyze data associated with device 120 (e.g., metadata associated with one or more social items), activities of a user associated with device 120, and filter and/or rank social items (e.g., items of interest) of a social sharing site utilized by the user. In an example, analytics 106 can analyze information associated with a variety of social items of a user and determine the social items of the user that are related to location of a user within a venue. In another example, analytics 106 may analyze an item of interest and/or posted message to identify: geolocation data, contextual words (e.g., spoken, included in a posted message, etc.), patterns of sharing, metadata tags, etc. In an alternative embodiment, one or more aspects of analytics 106 are purchased software solutions, hosted on another computing system (not shown) that are accessible via network 110.

Monitoring program 108 is a program that utilizes information from one or more instances of device 115 to determine real-time mobility data, such as speed, location, direction, dwell time, etc. for a user within a venue. In some embodiments, monitoring program 108 obtains at least the identity of device 120 from an instance of device 115. In one embodiment, monitoring program 108 obtains an identity of at least device 120 from social interest program 200. In another embodiment, monitoring program 108 obtains an identity of at least device 120 from network 110. Monitoring program 108 may identify device 120 based on: a service set identifier (SSID), a wireless communication media access control (MAC) address, a Bluetooth® MAC address, a unique identifier (UUID), and/or information embedded in a subscriber identity module (SIM) card within device 120.

In various embodiments, monitoring program 108 is a program that is included with an IPS that utilizes the one or more instances of device 115. In other embodiments, monitoring program 108 utilizes information within venue information 103 to map the movements of a user within the venue. Monitoring program 108 may cache and/or store mobility data of a user within a venue in storage 104 of server 102. In a further embodiment, monitoring program 108 communicates mobility data of a user to analytics 106 for additional analysis. In an example, monitoring program 108 includes venue information 103 with mobility data of a user to analytics 106 to determine items (e.g., inventory) of the venue that are within proximity of the user.

Social interest program 200 identifies a location of a user of device 120 within a venue and determines whether a user of device 120 inputs one or more items of interest to a social sharing site. In some embodiments, social interest program 200 executes concurrently with user monitoring program 300. In one embodiment, social interest program 200 interfaces with user monitoring program 300 to determine at least the mobility of device 120; thereby locating, in real-time, the position of a user of device 120 within a venue. In various embodiments, social interest program 200 utilizes networked computing environment 100 to access one or more social sharing sites utilized by a user to identify social items (e.g., items of interest) and one or more related organizations of social items to a user of device 120.

In an embodiment, social interest program 200 may modify an organization of one or more social items of a social sharing site of the user, based on a location of the user within the venue. In addition, social interest program 200 presents (e.g., displays) a modified organization of items of interest to a user of device 120 via user interface (UI) 122. In other embodiments, social interest program 200 utilizes analytics 106 to analyze and contextualize activities of a user to provide additional information utilized to modify one or more organizations of social items and to determine an order for the one or more organizations of social items. In a further embodiment, social interest program 200 utilizes one or more user preferences and/or criteria to generate an organization of social items that are identified within other organizations (e.g., boards). In one example, social interest program 200 identifies a top-ranked social item in each of four different boards and organizes the top-ranked social items within a fifth board (e.g., organization). In another example, social interest program 200 identifies a top-ranked and/or flagged social item within boards of other users associated with the users and organizes the identified social items within another organization.

User monitoring program 300 monitors and analyzes the activity of a user of a mobile device within a venue. In an embodiment, user monitoring program 300 utilizes monitoring program 108 and one or more instances of device 115 to determine mobility data of a user within a venue, such as locations, dwell times, movement paths, etc. In addition, user monitoring program 300 may also include venue information 103 in various analyses to determine when a user is within proximity to a zone and/or item that is related to an item of interest (e.g., a social item). In some embodiments, user monitoring program 300 may identify a non-movement-based activity of a user based on one or more interactions between a user of device 120 (e.g., a mobile computing device) and one or more apps executing on the device 120. In addition, user monitoring program 300 may update information associated with a user. In another embodiment, user monitoring program 300 transmits one or more alerts to a user moving within a venue via the mobile device of the user.

In various embodiments, user monitoring program 300 and social interest program 200 interface to exchange information, such as location information and/or items flagged by a user. In other embodiments, additional instances of user monitoring program 300 may execute in response to user monitoring program 300 determining that more than one social item and/or organization of social items are associated with a current visit by the user to a venue. An instance of user monitoring program 300 may be assigned to each organization of social items.

In one embodiment, server 102 communicates through network 110 to device 115, device 120, and social sharing site 130. Network 110 can be, for example, a local area network (LAN), a telecommunications network, a wireless local area network (WLAN) (e.g., an intranet), a wide area network (WAN), the Internet, or any combination of the previous and can include wired, wireless, or fiber optic connections. In general, network 110 can be any combination of connections and protocols that will support communications between server 102, device 115, device 120, and social sharing site 130, in accordance with embodiments of the present invention. In some scenarios, server 102 utilizes network 110 to access one or more instances of device 115 to communicate with device 120. In another embodiment, network 110 operates locally via wired, wireless, or optical connections and can be any combination of connections and protocols (e.g., personal area network (PAN), near field communication (NFC), laser, infrared, ultrasonic, etc.). In an alternative embodiment, server 102 may utilize a traffic monitoring program (not shown) to monitor a portion of network 110 that is associated with the venue to determine which social sharing site is accessed by device 120.

Device 115 is an electronic device that can wireles sly identify and locate device 120. Device 115 communicates the mobility data to server 102 via network 110. In one embodiment, device 115 may not be able to determine an identity for the user of device 120, based on security settings and/or active software apps of device 120. Device 115 may be limited to determining an identity for device 120. In various embodiments, a venue includes a plurality of instances of device 115, and the plurality of instances of device 115 is not limited to a single type of electronic device. Instances of device 115 may include, but are not limited to, beacons, sensors, wireless access points, and transceivers.

In some embodiments, an instance of device 115 is an electronic device, such as a beacon or a sensor that is limited to one-way communication with respect to device 120. In an example, one or more instances of device 115 utilizes one or more discovery protocols to identify device 120 and/or an identity for the user of device 120. In another example, an instance of device 115 transmits information to device 120. In addition, one or more instance of device 115 transmits various information, such as signal strength to server 102, via network 110 for analysis by a monitoring program that determines mobility data associated with device 120. In other embodiments, an instance of device 115 is an electronic device, such as a transceiver that is capable of two-way communication between device 120 and server 102. Device 115 may also detect and identify other electronics devices (e.g., RFID tags) that are in proximity to or travel with device 120.

In a further embodiment, one or more instances of device 115 may be part of an IPS and include electronics that enable instances device 115 to determine the physical location and direction of movement of device 120, in at least two dimensions. In some embodiments, one or more instances of device 115 also include various algorithms to determine an angle of arrival (AoA) and/or a direction of arrival (DoA) of device 120 relative to one or more zones defined within venue information 103 for various instances device 115. In other embodiments, device 115 communicates mobility data (e.g., signal strength, AoA) to server 102, where server 102 utilizes one or more algorithms of monitoring program 108 to determine additional mobility data for device 120, such as speed, path of movement, and dwell times (e.g., time of stay (ToS)) along a path of movement.

Device 120 includes: user interface (UI) 122, storage 123, and electronics to communicate wirelessly (not shown). Storage 123 includes user information 124 and various programs (not shown). Examples of programs that device 120 may include are: a web browser, an e-mail client, security software (e.g., a firewall program, a geo-locating program, an encryption program, etc.), a social sharing application (app), a telecommunication app, and one or more merchant apps. A user of device 120 can interact with the respective UI 122 via a singular interface device, such as a touch screen (e.g., display) that performs both as an input to a graphical user interface (GUI) and as an output device (e.g., a display) presenting a plurality of icons associated with software applications or images depicting the executing software application. Optionally, an app, such as a web browser can generate UI 122 operating within the GUI of device 120. In some instances, a videoconferencing app may utilize the display of device 120 to display a real-time interaction between users. In some embodiments, device 120 includes various input/output (I/O) devices (not shown), such as a digital camera, speaker, and/or a microphone.

In one embodiment, user information 124 includes security settings for device 120, such as authentication information and protocols (e.g., encryption schemes) utilized during communications (e.g., with network 110, server 102, etc.). In another embodiment, user information 124 includes one or more identities (e.g., user profiles) of users that share device 120. User information 124 may include information associated with a subscriber identity module (SIM) card of device 120.

In various embodiments, user information 124 may include various user preferences, tags, keywords, triggers with respect to social sharing and/or social items, reminders (e.g., a to-do list, a calendar entry, a message, etc.), and one or more local/temporary folders/files, which include organizational depictions of items-of-interest generated during a visit to a venue. Elements of organizational depiction that can be modified include: an order items, highlighting of an item, a size of an image representing an item, a text bubble included in an image of an item, etc. In addition, user information 124 may also include: minimum dwell times (e.g., dwell time threshold values) for a location, price sensitivity, opt-ins/opt-outs for various social sharing sites, interest board organization preferences, one or more temporary venue boards, a frequency of receiving alerts, a method of receiving alerts, a delay prior to receiving an alert, a delay prior to displaying a modified organization of social items, one or more predefined alerts/messages, etc. In a further embodiment, user information 124 includes various indications of priority and/or hierarchies associated with levels of interest/importance for social shares and/or the presentation of social shares.

UI 122 accepts input from a plurality of input/output (I/O) devices including, but not limited to, a tactile sensor interface (e.g., a touch screen, a touchpad), a natural user interface (e.g., a voice control unit, a camera, a motion capture device, eye tracking, etc.), or a peripheral device. An I/O device interfacing with a UI 122 may be connected to an instance of device 120, which may operate utilizing a wired connection, such as a universal serial bus port (USBTM port) or wireless network communications (e.g., infrared, NFC, etc.). For example, an I/O device may be a peripheral, such as a keyboard, a mouse, a trackball, a click wheel, or a headset that provides input from a user.

In an embodiment, UI 122 may be a graphical user interface (GUI) or a web user interface (WUI). UI 122 can display text, documents, forms, web browser windows, user options, application interfaces, and instructions for operation; and include the information, such as graphics, text, and sounds that a program presents to a user. In addition, UI 122 controls sequences/actions that the user employs to access social sharing site 130, update user information, and respond to an alert from social interest program 200 and/or user monitoring program 300. In some embodiments, a user of client device 120 can interact with UI 122 via a singular device, such as a touch screen (e.g., display) that performs both as an input to a GUI/WUI, and as an output device (e.g., a display) presenting a plurality of icons associated with apps and/or images depicting one or more executing software applications. In other embodiments, a software program (e.g., a web browser) can generate UI 122 operating within the GUI environment of client device 120. In various embodiments, UI 122 may receive input in response to a user of device 120 utilizing natural language, such as writing words or speaking words, that device 120 identifies as information and/or commands.

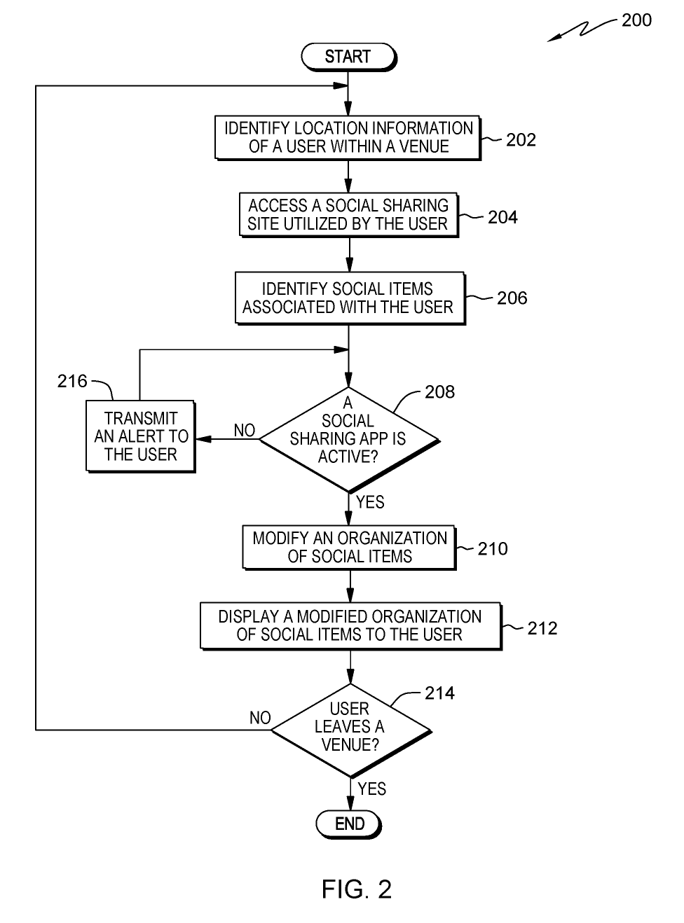

FIG. 2 is a flowchart depicting operational steps for social interest program 200, a program for identifying two or more items of interest within social items of a user that are included in a social sharing site and modifying an organization associated with the two or more items of interest, based on location information of the user within a venue, in accordance with embodiments of the present invention. In various embodiments, social interest program 200 executes concurrently with user monitoring program 300 and interfaces with user monitoring program 300 to communicate mobility information (e.g., locations, paths, dwell times, etc.). In other embodiments, additional instances of social interest program 200 may execute in response to user monitoring program 300 determining, based on information of the user of device 120, that more than one item of interest and/or social shares are associated with a current visit by the user to a venue.

In step 202, social interest program 200 identifies location information of a user within a venue. Social interest program 200 identifies location information and an identity of a user based on information obtained from device 120. In one embodiment, social interest program 200 utilizes monitoring program 108 to identify location information of a user within a venue. In another embodiment, social interest program 200 interfaces with user monitoring program 300 to obtain location information of a user within a venue. In an alternative embodiment, social interest program 200 is constrained to identify and track device 120 and cannot initially determine an identity of a user of device 120.

In some embodiments, social interest program 200 utilizes both monitoring program 108 and user monitoring program 300 to identify location information associated with a user within a venue. In other embodiments, social interest program 200 interfaces with user monitoring program 300 to obtain additional location information (e.g., mobility information), such as speed, dwell times, direction (e.g., path), etc., of a user moving within the venue. In various embodiments, social interest program 200 identifies the location of a user within a venue based on venue information 103 and information from one or more instances of device 115.

In step 204, social interest program 200 accesses a social sharing site utilized by the user. In one embodiment, social interest program 200 communicates with device 120, via network 110, to access a social sharing site (e.g., social sharing site 130) that is currently being accessed by device 120. In another embodiment, social interest program 200 accesses a social sharing site based on information included on user information 124 of device 120. In an example, social interest program 200 queries device 120, via network 110, to identify one or more social sharing sites that the user is currently utilizing (e.g., accessing). Social interest program 200 may identify social sharing sites of a user based on information included in user information 124 and/or apps installed/active on device 120. In response to identifying a social sharing site, social interest program 200 accesses one or more identified social sharing sites. Social interest program 200 may access social sharing site 130 as a “guest.” In some embodiments, social interest program 200 may filter which social sharing sites are accessed based on information associated with the venue visited by the user of device 120. In an example, social interest program 200 may determine not to access a social sharing site associated with travel during a visit by the user to a home improvement venue.

In various embodiments, social interest program 200 identifies and accesses one or more social sharing sites based on other information. In one scenario, social interest program 200 accesses a social sharing site that is associated with a merchant app executing on device 120. In another scenario, social interest program 200 identifies a social sharing site utilized by the user of device 120 based on monitoring wireless communications within a venue. In one example, a user of device 120 utilizes a “free” wireless communication network provided by a venue as opposed to utilizing a telecommunication data plan associated with device 120. Social interest program 200 may interface with a monitoring program that tracks communication traffic of network 110 of the venue.

In step 206, social interest program 200 identifies social items associated with the user. In one embodiment, social interest program 200 identifies (e.g., filters) information associated with items of interest from a social sharing site based on the location of a user within a venue. In a scenario, social interest program 200 utilizes location information of the user within the venue, one or more items of interest of the user of social sharing site 130, one or more preferences of the user, and analytics 106 to identify social items associated with the user. In one example, social interest program 200 utilizes venue information 103 to identify items of the venue that are included in a zone, proximity, and/or location of a user, and compare the identified items to social items of the user. Social interest program 200 may utilize various aspects of analytics 106 to identify social items based on tags (e.g., metadata) of items included in venue information 103 at a location of a user and one or more social items of the user included in social sharing site 130. In another embodiment, social interest program 200 determines, based on various user preferences and/or indications, that items of interest to the user are based on social shares (e.g., items) of another user, such as looking for a birthday present for a friend. Social interest program 200 may utilize social shares of the other user and a location of the user within the venue to identify one or more social items.

In some embodiments, social interest program 200 analyzes social items to determine information associated with the social items, such as geolocation tags, metadata tags (e.g., keywords), patterns of sharing, and manual tags included by a user. In various embodiments, social sharing program 200 further identifies social items of a user by utilizing one or more aspects of analytics 106 to determine contextual tags. Social sharing program 200 may utilize analytics 106 to determine contextual tags based on: image processing of social items, ranking social items based on patterns of sharing (e.g., popularity, user involved in sharing, share count, etc.), synonyms of tags identified by a thesaurus function, etc.

Still referring to step 206 in a further embodiment, social interest program 200 combines location information of the user within the venue, one or more items of interest of the user of social sharing site 130, one or more preferences of the user, and analytics 106 to identify social items associated with the user. In an example, a user of device 120 indicates within social sharing site 130 that the user is interested in three household projects: a garden project, a home repair project, and a project for a child and includes various images associated with each project on a board of social sharing site 130. In one instance, social interest program 200 determines that the user is located in the garden center of the venue; therefore, at least social items associated with garden projects are identified. However, analytics 106 also indicates to social interest program 200 that one item associated with a board for the project for the child is also within the garden center, a hummingbird feeder. Social interest program 200 includes the hummingbird feeder as an identified social item. In another example, social interest program 200 may utilize analytics 106 and venue information 103 to filter the identification of social items based on price sensitivity. In another instance, social interest program 200 does not identify a social item in response to the user traversing a zone of regularly priced merchandise. However, if venue information 103 indicates that an item of interest exists in a clearance price zone, then social interest program 200 identifies the social item in response to the user traversing the clearance price zone of the venue.

In decision step 208, social interest program 200 determines that a social sharing app is active. In one embodiment, social interest program 200 determines that a social sharing app is active based on accessing a social sharing site via device 120 in step 204. In another embodiment, social interest program 200 determines that a social sharing app is active on device 120, based on identifying device 120 communicating with social sharing site 130 via network 110. In an alternative embodiment, social interest program 200 determines that a social sharing app is not active. Responsive to determining that a social sharing app is active (Yes branch, decision step 208), social sharing program 200 modifies an organization of social items (Step 210).

In step 210, social sharing program 200 modifies an organization of social items. In various embodiments, social sharing program 200 modifies an organization of social items of one or more organizations of items of social sharing site 130. In one embodiment, social sharing program 200 modifies an organization of social items of a user, based on one or more organizations of representative of items (e.g., groups, boards, lists, etc.) and a location of the user. In one scenario, social sharing program 200 continually modifies one or more organizations of social items based on a user entering another area (e.g., zone) of a venue. In some scenarios, social sharing program 200 delays a modification of an organization of social items of a user, based on at least one trigger and/or threshold value, such as a speed of a user within a zone of a venue. In an example, social sharing program 200 determines that the speed of a user traversing a zone indicates lack of interest in items of the zone and in response maintains a current organization of social items. In other scenarios, social sharing program 200 modifies an organization of social items, based on meeting (e.g., equal to or greater than) a dwell time and/or a value of dwell time threshold of a user within a location of a venue. Social sharing program 200 may utilize one or more aspects of user monitoring program 300 to determine a dwell time of a user.

In some embodiments, social interest program 200 includes one or more activities of a user to determine whether to modify an organization of social items. In one scenario, social interest program 200 includes information of a user (e.g., user information 124), such as a flag or calendar entry to trigger a modification of an organization of social items at a location within a venue. In another scenario, social interest program 200 includes activity information of a user, obtained from user monitoring program 300, to determine whether to modify an organization of social items. In one example, social interest program 200 receives information from user monitoring program 300 based on analytics 106 identifying verbal or text-based communications among users that are associated with an item located in a venue. Social interest program 200 may modify an organization of social items based on the proximity of a user to an item identified by analytics 106. In another example, social interest program 200 includes a change to a social sharing site 130 to trigger a modification of an organization of social items, based on at least a location within a venue, such as in response to two or more users shopping collaboratively.

Still referring to step 210 in other embodiments, social sharing program 200 modifies one or more organizations of social items and stores the modified organizations of items in one or more temporary folders. Social sharing program 200 may store the temporary folder of organizations of social items in storage 104 of server 102 and/or storage 103 of device 120. In one scenario, social interest program 200 deletes temporary folders in response to determining that a user leaves a venue. In some scenarios, social interest program 200 interfaces with user monitoring program 300 to store one or more temporary folders for a predetermined time in a storage location associated with the information of a user. In other scenarios, social interest program 200 interfaces with UI 122 of device 120 and user monitoring program 300 to store one or more temporary folders, based on input of a user, in a storage location associated with the information of the user. In an alternative embodiment, social interest program 200 modifies an organization of social items based on a different and/or specific trigger, such as determining that a user selects an item of the venue, based on detecting an RFID tag of the item in proximity of the user, or detecting that device 120 scans an item (e.g., a barcode of the item, a QR code of the item).

In step 212, social interest program 200 displays a modified organization of social items to the user. In various embodiments, social interest program 200 displays a modified organization of social items to the user by transmitting the modified organization of social items to device 120 for rendering by an instance of UI 122. Instances of UI 122 may be associated with a function of social interest program 200, a web browser, a UI of social sharing site 130, etc. In one scenario, social interest program 200 transmits a modified organization of social items to device 120 in response to identifying a modification of an organization of social items. In other scenarios, social interest program 200 may delay a transmission of a modified organization of social items to device 120 based on one or more criteria, such as a dwell time at a location within a venue that is less than a threshold value. In another scenario, social interest program 200 delays the display of a transmitted organization of social items by embedding a trigger that awaits another command, such as a criterion is met. In some embodiments, social interest program 200 transmits instructions (e.g., an indication) to display a previous organization of social items, stored in a temporary folder on device 120, as opposed to a modified organization of social items that is transmitted. In an example, social interest program 200 reverts the display of an organization of social items to a previous organization of social items based on one or more user preferences, such as time, a distance between zones of a venue that include an item related to a social item, a value associated with a previous organization (e.g., one organization back), etc.

In other embodiments, social interest program 200 transmits and/or selects another organization of social items based on receiving an input of a user via UI 122 that indicates an organization of social items to display. In an example, social interest program 200 displays a selection of two or more organizations of social items generated during a visit of a user to a venue via UI 122. The two or more organizations of social items may be depicted in a reduced size format within UI 122, and in response to receiving a selection of a user social interest program 200 instructs device 120 to display the selected organization of social items at an increased size. In a further embodiment, social interest program 200 may receive input of a user input via UI 122, in response to a displayed organization of social items. In one scenario, social interest program 200 receives an input of a user that identifies an item of an organization of items for deletion. In another scenario, social interest program 200 receives an input of a user that identifies an item of an organization of items that is locked (e.g., remains at the same position within an organization). In some scenarios, social interest program 200 receives an input of a user that flags an organization of social items that is a default organization of social items that device 120, via UI 122 displays in response to an indication to revert to a previous organization.

Still referring to step 212 in a different embodiment, social interest program 200 displays the modified organization of social items to the user via an electronic device that is not device 120. In one example, social interest program 200 displays the modified organization of social items to the user via another electronic device, such as electronic signage of a venue that is in proximity to the user, a device of a customer service representative, or a display of an electronic sales terminal. In another example, social interest program 200 communicates (e.g., via a message, via a change to a social sharing site, etc.) a modified organization of social items to a device of another user.

In decision step 214, social interest program 200 determines whether a user leaves a venue. In one embodiment, social interest program 200 determines that device 120, and by inference a user of device 120, leaves a venue based on monitoring program 108 determining that none of the instances of device 115 identifies a location of device 120 relative to venue information 103. In another embodiment, social interest program 200 determines that a user leaves a venue based on that device 120 ceases to utilize a portion of network 110 that is associated with the venue. In an alternative embodiment, social interest program 200 determines that a second user leave a second venue and/or stops collaborating with a first user within a first venue based on analytics 106 identifying one or more received indication. In one example, social interest program 200 determines that a second user leave a second venue based on analytics 106, using NLP, a message transmitted to a user of 120 by the second user that indicates such, such as “Bye,” “See you later,” “Leaving now,” etc. In another example, social interest program 200 infers that a second user leave a second venue based on analytics 106 determining that the second user stops collaborating via social sharing site 130. Responsive to determining that a user leaves a venue (Yes branch, decision step 214), social interest program 200 terminates.

Responsive to determining that a user does not leaves a venue (No branch, decision step 214), social interest program 200 loops to identify a location of a user within the venue (step 202).

Referring to decision step 208, responsive to determining that a social sharing app is not active (No branch, decision step 208), social interest program 200 transmits an alert to the user (step 216). In an alternative embodiment in decision step 208, social interest program 200 does not transmit an alert to a user of device 120 in response to determining that a social app is not active and based on one or more user preferences. In one scenario, social interest program 200 delays transmitting an alert based on a user preference (e.g., in storage 104 of server 102, in user information 124 of device 120) of a frequency of receiving an alert for a determination that a social app is not active. In another scenario, social interest program 200 does not transmit an alert for a determination that a social app is not active based on a response (e.g., ignore, dismiss) input by a user via UI 122 of device 120.

In step 216, social interest program 200 transmits an alert to the user. In an embodiment, social interest program 200 transmits an alert to a user of device 120 based on one or more user preferences (e.g., in storage 104 of server 102, in user information 124 of device 120). Examples of alerts transmitted to device 120 include: a text message, an e-mail, a synthesized voice response, etc. In addition, social interest program 200 may include a physical action of device 120 indicating to a user of device 120 that an alert is received, such as a haptic event and/or a sound.

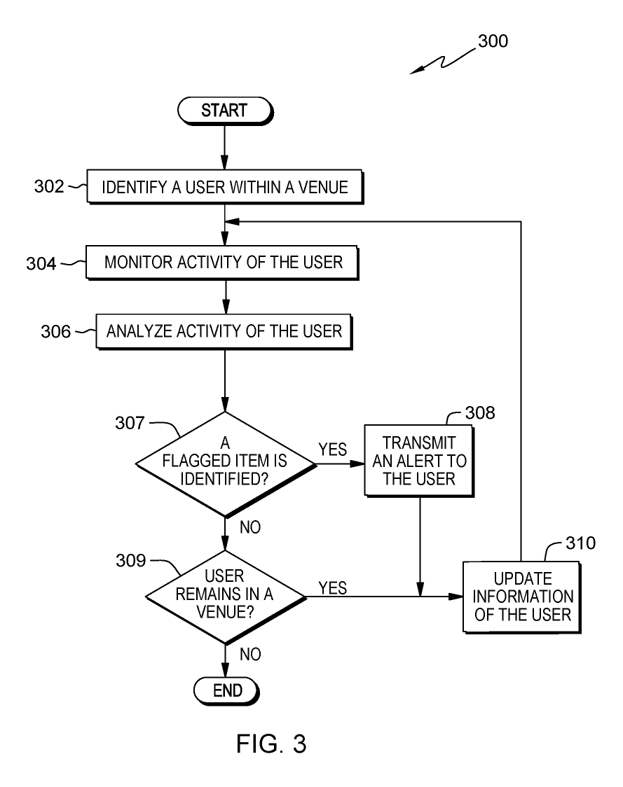

FIG. 3 is a flowchart depicting operational steps for user monitoring program 300, a program for monitoring and analyzing the activity of a user of a mobile device within a venue, in accordance with embodiments of the present invention. In some embodiments, user monitoring program 300 may identify an activity of a user based one or more interactions between a user of device 120 (e.g., a mobile computing device) and one or more apps executing on the device 120. In addition, user monitoring program 300 may update information associated with a user. In another embodiment, user monitoring program 300 transmits one or more alerts to a user moving within a venue, via the mobile device of the user. In various embodiments, user monitoring program 300 executes concurrently with social interest program 200 and interfaces with social interest program 200 to communicate information. In other embodiments, additional instances of user monitoring program 300 may execute in response to user monitoring program 300 determining, based on information of the user of device 120, that more than one item of interest and/or social shares are associated with a current visit by the user to a venue.

In step 302, user monitoring program 300 identifies a user within a venue. In some embodiments, user monitoring program 300 identifies a user based on information obtained from device 120 via network 110. In one scenario, user monitoring program 300 utilizes information obtained by an instance of device 115 to at least identify device 120. In another scenario, user monitoring program 300 utilizes a monitoring program that tracks communication traffic of network 110 of the venue. In an example, if a user of device 120 utilizes a “free” wireless communication network provided by a venue, then user monitoring program 300 may identify the user of device 120 based on: a service set identifier (SSID), a universally unique identifier (UUID), a name, etc., which is stored in storage 123 of device 120.

In other embodiments, user monitoring program 300 identifies a user within a venue based on a social sharing app that is executing on device 120. In another embodiment, user monitoring program 300 identifies a user of device 120 based on an app associated with the venue. For example, monitoring program 300 identifies the user of device 120 within a venue based on a marketing app of the merchant that is located in the venue.

In various embodiments, user monitoring program 300 communicates identification information identified of a user of device 120 to social interest program 200. In a further embodiment, user monitoring program 300 identifies and obtains additional information of the user that is stored in storage 123 of device 120, such as one or more social sharing sites utilized by the user, one or more user preferences, one or more items of interest that are flagged, the number of social shares that are active for an instance of the user within a venue, names and/or IDs of other users, etc. In addition, user monitoring program 300 may utilize one or more other programs, such as an aspect of analytics 106 to determine: tags, metadata, a hyperlink, etc. associated with a representation, such as a picture of an item of interest stored on device 120 and/or identify (e.g., via image recognition) the item of interest.

In step 304, user monitoring program 300 monitors activity of the user. In one embodiment, user monitoring program 300 utilizes monitoring program 108 to determine one or more real-time aspects of movement based activity related to device 120 relative to one or more instances of device 115, and, by inference, activity of the user of device 120. Aspects of movement based activity include, but are not limited to, a position of device 120 and a speed related to device 120. In some embodiments, user monitoring program 300 dictates that monitoring program 108 includes venue information 103 to monitor the movement activity related to device 120. User monitoring program 300 receives more accurate and/or granular information from monitoring program 108. For example, user monitoring program 300 receives information, such as but not limited to, a position within a zone of a venue, an AoA and/or an DoA of device 120 relative to one or more instances of device 115 within the venue, a speed of device 120, and one or more dwell times of device 120 within a location (e.g., zone) of the venue.

In various embodiments, user monitoring program 300 communicates a location of device 120, and, by inference, the location of a user to social interest program 200. In further embodiments, user monitoring program 300 identifies one or more activities associated with device 120 and/or a user of device 120 not associated with movement. In one scenario, user monitoring program 300 determines that another activity of a user of device 120 is collaborative interactions with other users, such as comparison shopping.

Still referring to step 304, in another scenario, user monitoring program 300 determines that a user of device 120 interacts with an element of a venue, such as a piece of merchandise and/or a customer service representative. In one scenario, user monitoring program 300 may determine that a user examines a piece of merchandise based on: monitoring program 108 identifying an RFID tag of the merchandise, a user uploads an image of the merchandise to a social sharing site, utilizes a barcode or QR code scanner of the venue, etc. In another scenario, user monitoring program 300 may determine that a user interacts with a customer service representative of the venue based on identifying a mobile device (not shown) and/or passive identifier (e.g., RFID badge) of the customer service associate. The interaction may include a user of device 120 obtaining information related to an item within the venue. In an example, user monitoring program 300 determines that device 120 receives information of a merchant app related to an item of the venue.

In step 306, user monitoring program 300 analyzes activity of the user. In one embodiment, user monitoring program 300 utilizes one or more aspects of analytics 106 to analyze the position based activity of the user within a venue. In some embodiments, user monitoring program 300 utilizes a response from analytics 106 to select among items of interest of a user of device 120. In one example, user monitoring program 300 may rank the item of interest, an indoor project, higher (e.g., more probable) in response to analytics 106 determining that the user of device 120 delayed in a window treatment department prior to traveling to a paint department. Alternatively, user monitoring program 300 may rank the item of interest, an outdoor project, higher (e.g., more probable) in response to analytics 106 determining that the user of device 120 delayed in a gardening department and a lumber department prior to traveling to a paint department.

In an alternative embodiment, user monitoring program 300 analyzes the activity of a user based on receiving “item of interest” information communicated by social interest program 200. In one example, user monitoring program 300 receives item of interest information based on a message posted to a pinned item included in social sharing site 130. In another example, user monitoring program 300 identifies an item of interest based on analyzing a change (e.g., an update) to a social share by another user that in monitored by the user of device 120, such as two or more user engaged in collaborative shopping. User monitoring program 300 may utilize one or more aspects of analytics 106 to monitor and/or identify real-time changes of information of a social sharing site associated with a user of device 120. In an example, user monitoring program 300 utilizes analytics 106 to determine information (e.g., metadata) identifying one or more other users, based on metadata associated with one or more items of interest added to a social share of the user of device 120. In this example, analytics 106 identifies that another user engaged with the user of device 120 based on metadata of: an item added to a wish-list, an image included (e.g., attached, “pinned”) to a digital bulletin or sharing board, a text message and/or image associated with a digital conversation (e.g., thread), etc. In a different embodiment, user monitoring program 300 identifies an activity of the user based on device 120 utilizing network 110. In an example, user monitoring program 300 determines that the user performs an Internet search for plant hardiness while in the garden center of the venue.

In decision step 307, user monitoring program 300 determines whether a flagged item is identified. In one embodiment, user monitoring program 300 determines that a flagged item is identified based on information communicated by social interest program 200 and one or more analyzed activities of a user of device 120. In another embodiment, user monitoring program 300 determines that a flagged item is identified based on information of a user stored in user information 124, such as a digital to-do list and one or more analyzed activities of the user of device 120. In an alternative embodiment, user monitoring program 300 identifies a flagged item based on an app associated with a venue, such as a gift registry and one or more analyzed activities (e.g., a location) of the user of device 120 within the venue. In a further embodiment, user monitoring program 300 identifies a flagged item based on input from analytics 106, such as a user taking a picture of a pet of another customer triggering a flag of “flea treatment” and/or “fence repair.” Responsive to determining that a flagged item is identified (Yes branch, decision step 307), user monitoring program 300 transmits an alert to the user.

In step 308, user monitoring program 300 transmits an alert to the user. In an embodiment, user monitoring program 300 transmits, via network 110, an alert to the user of device 120 that is associated with a flagged item. Examples of alerts include, but are not limited to, a text message, an e-mail, a sound, a synthesized voice mail message, a recorded message, and a haptic event (e.g., device 120 vibrates). In another embodiment, user monitoring program 300 activates, via network 110, an alert stored in user information 124. In one example, user monitoring program 300 activates an alert (e.g., a recorded message), created by a user of device 120 that stored in user information 124, such as “ . . . check prices and colors for stone edging for the garden.” In another example, user monitoring program 300 activates an alert stored in user information 124 that was received from social sharing site 130.

In some embodiments, user monitoring program 300 interfaces with social sharing program 200 to transmit an alert to the user of device 120 based on a flagged item that is associated with a social item and/or an item of interest. In an example, user monitoring program 300 identifies a flagged item that is associated with one or more social items of a user and social interest program 200 subsequently displays the flagged item as part of a modified organization of social items (step 212). In an alternative embodiment, user monitoring program 300 may utilize network 110 and a device of the venue, such as electronic signage or a printer of a sales terminal, to transmit an alert to the user. In an example, user monitoring program 300 includes an alert (e.g., message) at the bottom of a sales receipt in response to a user of device 120 purchasing one or more items.

Referring to decision step 307, responsive to determining that a flagged item is not identified (No branch, decision step 307), user monitoring program 300 determines whether a user remains in a venue (decision step 309).

In decision step 309, user monitoring program 300 determines whether a user remains in a venue. In one embodiment, user monitoring program 300 determines that device 120, and by inference a user of device 120, remains in a venue based on monitoring program 108 utilizing one or more instances of device 115 to identify a location of device 120 relative to venue information 103. In another embodiment, user monitoring program 300 determines that a user remains within a venue based on device 120 utilizing a portion of network 110 that is associated with the venue. In some embodiments, user monitoring program 300 determines that device 120 remains in a venue based on polling device 120 and network 110 detecting a wireless communication signal, such as an SSID, a wireless communication media access control (MAC) address, a Bluetooth® MAC address, and/or other identifier of device 120 within the venue.

Responsive to determining that a user remains in a venue (Yes branch, decision step 309), user monitoring program 300 updates information of the user (step 310).

In step 310, user monitoring program 300 updates information of the user. In one embodiment, user monitoring program 300 updates information of the user of device 120 based on the analyzed movement activity of the user. In an example, user monitoring program 300 updates the information of the user associated with one or more locations of device 120, movement (e.g., direction, speed, etc.) of device 120 and dwell times of device 120 within the venue. In another embodiment, user monitoring program 300 updates additional information of the user based on one or more other activities of a user, such as a change to a social item included in social sharing site 130. In an example, user monitoring program 300 updates information of the user based on determining that two or more users utilize social sharing site 130 to collaboratively shop in a first venue and a second venue. In another example, user monitoring program 300 updates information of the user based on identifying a change to social sharing site 130, such as a spouse not at the venue updating one or more “do it yourself” (DIY) items of interest pinned to a pin board of the household of the user of device 120.

In some embodiments, user monitoring program 300 updates information of the user stored in user information 124 of device 120. In an example, user monitoring program 300 determines that a user of device 120 utilizes UI 122 to indicate to save a copy of a current organization of social items to user information 124. In other embodiments, user monitoring program 300 caches and/or stores some information of the user on server 102. In an example, user monitoring program 300 updates information of the user that is stored in storage 104 of server 102 that is associated with one or more flagged items and/or alerts transmitted for an identified flagged item.

Still referring to step 310 in an alternative embodiment, user monitoring program 300 updates information of the user based on input from the user of device 120. In one example, user monitoring program 300 updates information of the user associated with a frequency of alerts transmitted by social interest program 200. In another example, user monitoring program 300 updates information of the user that is generated by social interest program 200, such as a modified organization of social items that the user of device 120 indicates to store for future reference. Based on the information and the context of the information, user monitoring program may update information of the user in storage 104 or server 102 and/or user information 124 on device 120. Subsequent to user monitoring program 300 updating information of the user, user monitoring program 300 loops to continue monitoring the user.

Referring to decision 309, responsive to determining that a user does not remain in a venue (No branch, decision step 309), user monitoring program 300 terminates.

FIG. 4 depicts computer system 400, which is representative of server 102, device 115, and device 120, and social sharing site 130. Computer system 400 is an example of a system that includes software and data 412. Computer system 400 includes processor(s) 401, memory 402, cache 403, persistent storage 405, communications unit 407, I/O interface(s) 406, and communications fabric 404. Communications fabric 404 provides communications between memory 402, cache 403, persistent storage 405, communications unit 407, and I/O interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processor(s) 401 by holding recently accessed data, and data near recently accessed data, from memory 402.

Program instructions and data used to practice embodiments of the present invention may be stored in persistent storage 405 and in memory 402 for execution by one or more of the respective processor(s) 401 via cache 403. In an embodiment, persistent storage 405 includes a magnetic hard disk drive. Alternatively, or in addition to a magnetic hard disk drive, persistent storage 405 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405. With respect to device 120, storage 405 may include a SIM card. Software and data 412 are stored in persistent storage 405 for access and/or execution by one or more of the respective processor(s) 401 via cache 403 and one or more memories of memory 402. With respect to server 102, software and data 412 includes venue information 103, analytics 106, monitoring program 108, social interest program 200, user monitoring program 300, and various programs and data (not shown) included in storage 104. With respect to device 120, software and data 412 includes UI 122, user information 124, and various information and programs (not shown).

Communications unit 407, in these examples, provides for communications with other data processing systems or devices, including resources of server 102, device 115, device 120, and social sharing site 130. In these examples, communications unit 407 includes one or more network interface cards. Communications unit 407 may provide communications through the use of either or both physical and wireless communications links. Program instructions and data used to practice embodiments of the present invention may be downloaded to persistent storage 405 through communications unit 407.

I/O interface(s) 406 allows for input and output of data with other devices that may be connected to each computer system. For example, I/O interface(s) 406 may provide a connection to external device(s) 408, such as a keyboard, a keypad, a touch screen, and/or some other suitable input device. External device(s) 408 can also include portable computer readable storage media, such as, for example, thumb drives, portable optical or magnetic disks, and memory cards. Software and data 412 used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor. Display 409 can also function as a touch screen, such as the display of a tablet computer or a smartphone.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for adjusting a displayed organization of a representative collection of items, the method comprising:
identifying, by one or more computer processors, a first user within a first location;
determining, by one or more computer processors, a first set of location information associated with the first user within the first location and information associated with the first location;
identifying, by one or more computer processors, a first group of representations of items of interest of the first user and a first organization of the first group of representations of items;
generating, by one or more computer processors, a second organization of the first group of representations of items by modifying the first organization of the first group of representations of items wherein the generated second organization is based on the first set of location information associated with the user within the first location; and
rendering, by one or more computer processors, the second organization of the first group of representations of items for display by an electronic device.

2. The method of claim 1, further comprising:
transmitting, by one or more computer processors, the second organization of the first group of representations of items to the electronic device.

3. The method of claim 1, wherein a set of location information associated with the first user is determined utilizing a tracking system of a venue, and wherein the set of location information associated with the first user within the venue is determined in real-time.

4. The method of claim 3, wherein the set of location information associated with the first user includes: a position within the venue, a set of tags corresponding to one or more items of the venue located at the position within the venue, and a speed of movement within the venue.

5. The method of claim 3, wherein the venue includes a plurality of items, and wherein at least one item of the plurality of items of the venue corresponds to an item of interest within the first group of representations of items of interest of the first user.

6. The method of claim 1, further comprising:
accessing, by one or more computer processors, a social sharing website utilized by the first user; and
identifying, by one or more computer processors, a first plurality of items of interest of the first user based, at least in part, on social shares of the first user within the social sharing website, wherein the first plurality of items of interest includes the first group of representations of items of interest of the first user and the first organization of the first group of representations of items.

7. The method of claim 1, further comprising:
determining, by one or more computer processors, a first dwell time of the first user at a first position within a venue based on analyzing the first set of location information;
identifying, by one or more computer processors, a threshold value associated with a dwell time that is associated with the first user;
determining, by one or more processors, that the first dwell time for the first user at the first location is less than the threshold value associated with the dwell time that is associated with the first user; and
responsive to determining that the first dwell time for the first user at the first location is less than the threshold value associated with the dwell time that is associated with the first user, maintaining, by one or more computer processors, the first organization of the first group of representation of items of interest of the first user.

8. The method of claim 5, further comprising:
determining, by one or more computer processors, a second set of location information associated with the first user;
determining, by one or more computer processors, a second dwell time of the first user at a second position within a venue based on analyzing the second location information;
identifying, by one or more computer processors, a threshold value associated with a dwell time that is associated with the first user;
determining, by one or more processors, that the second dwell time for the first user at the second location is equal to or greater than a threshold value associated with the second dwell time of the first user; and
responsive to determining that the second dwell time for the first user at the second location is equal to or greater than the threshold value associated with the dwell time that is associated with the first user, modifying, by one or more computer processors, the first organization of the first group of representations of items of interest of the first user based on the second location of the first user to generate a third organization of the first group of representations of items of interest of the first user.

9. A computer program product for adjusting a displayed organization of a representative collection of items, the computer program product comprising:
one or more computer readable storage media and program instructions stored on the one or more computer readable storage media, the program instructions readable/executable by one or more computer processors, the program instructions comprising:
program instructions to identify a first user within a first location;
program instructions to determine a first set of location information associated with the first user within the first location and information associated with the first location;
program instructions to identify a first group of representations of items of interest of the first user and a first organization of the first group of representations of items;
program instructions to generate a second organization of the first group of representations of items by modifying the first organization of the first group of representations of items wherein the generated second organization is based on the first set of location information associated with the user within the first location; and
program instructions to rendering the second organization of the first group of representations of items for display by an electronic device.

10. The computer program product of claim 9, further comprising:
program instructions to transmit the second organization of the first group of representations of items to the electronic device.

11. The computer program product of claim 9, wherein a set of location information associated with the first user is determined utilizing a tracking system of a venue, and wherein the set of location information associated with the first user within the venue is determined in real-time.

12. The computer program product of claim 11, wherein the set of location information associated with the first user includes: a position within the venue, a set of tags corresponding to one or more items of the venue located at the position within the venue, and a speed of movement within the venue.

13. The computer program product of claim 11, wherein the venue includes a plurality of items, and wherein at least one item of the plurality of items of the venue corresponds to an item of interest within the first group of representations of items of interest of the first user.

14. The computer program product of claim 9, further comprising:
program instructions to access a social sharing website utilized by the first user; and
program instructions to identify a first plurality of items of interest of the first user based, at least in part, on social shares of the first user within the social sharing website, wherein the first plurality of items of interest includes the first group of representations of items of interest of the first user and the first organization of the first group of representations of items.

15. The computer program product of claim 9, further comprising:
program instructions to determine a first dwell time of the first user at a first position within a venue based on analyzing the first set of location information;
program instructions to identify a threshold value associated with a dwell time that is associated with the first user;
program instructions to determine that the first dwell time for the first user at the first location is less than the threshold value associated with the dwell time that is associated with the first user; and
program instruction to respond to determining that the first dwell time for the first user at the first location is less than the threshold value associated with the dwell time that is associated with the first user by maintaining the first organization of the first group of representation of items of interest of the first user.

16. The computer program product of claim 13, further comprising:
program instructions to determine a second set of location information associated with the first user;
program instructions to determine a second dwell time of the first user at a second position within a venue based on analyzing the second location information;
program instructions to identify a threshold value associated with a dwell time that is associated with the first user;
program instructions to determine that the second dwell time for the first user at the second location is equal to or greater than a threshold value associated with the second dwell time of the first user; and
program instructions to respond to determining that the second dwell time for the first user at the second location is equal to or greater than the threshold value associated with the dwell time that is associated with the first user by modifying the first organization of the first group of representations of items of interest of the first user based on the second location of the first user to generate a third organization of the first group of representations of items of interest of the first user.

17. A computer system for adjusting a displayed organization of a representative collection of items, the computer system comprising:
one or more computer processors;
one or more computer readable storage media; and
program instructions stored on the computer readable storage media, the program instructions readable/executable for execution by at least one of the one or more computer processors, the program instructions comprising:
program instructions to identify a first user within a first location;
program instructions to determine a first set of location information associated with the first user within the first location and information associated with the first location;
program instructions to identify a first group of representations of items of interest of the first user and a first organization of the first group of representations of items;
program instructions to generate a second organization of the first group of representations of items by modifying the first organization of the first group of representations of items wherein the generated second organization is based on the first set of location information associated with the user within the first location; and
program instructions to rendering the second organization of the first group of representations of items for display by an electronic device.

18. The computer system of claim 17, wherein a set of location information associated with the first user is determined utilizing a tracking system of a venue, and wherein the set of location information associated with the first user within the venue is determined in real-time.

19. The computer system of claim 18, wherein the set of location information associated with the first user includes: a position within the venue, a set of tags corresponding to one or more items of the venue located at the position within the venue, and a speed of movement within the venue.

20. The computer system of claim 18, wherein the venue includes a plurality of items, and wherein at least one item of the plurality of items of the venue corresponds to an item of interest within the first group of representations of items of interest of the first user.
